(19) United States
(12) Patent Application Publication
(10) Pub. No.: US 2008/0319773 A1
(43) Pub. Date: Dec. 25, 2008

(54) PERSONALIZED TRAVEL GUIDE

(75) Inventors: Curtis G. Wong, Medina, WA (US); James E. Allard, Seattle, WA (US); David Sebastien Alles, Seattle, WA (US); Nicholas R. Baker, Cupertino, CA (US); Adam T. Berns, Bellevue, WA (US); Steven Drucker, Bellevue, WA (US); Todd E. Holmdahl, Redmond, WA (US); Oliver R. Roup, Seattle, WA (US); David H. Sloo, Menlo Park, CA (US); Dawson Yee, Bellevue, WA (US)

Correspondence Address: AMIN, TUROCY & CALVIN, LLP, 127 Public Square, 57th Floor, Key Tower, CLEVELAND, OH, 44114, US

(73) Assignee: MICROSOFT CORPORATION, Redmond, WA (US)

(21) Appl. No.: 11/766,689

(22) Filed: Jun. 21, 2007

(51) Int. Cl. G06Q 50/00

(52) U.S. Cl. 705/1

(57) ABSTRACT

The claimed subject matter relates to architectures for providing and accessing a service that facilitates an enhanced travel experience. The architectures can determine a location of a subscribing mobile device, match a profile relating to the device with available guides for a site in proximity to the location, and transmit a notification to the device of the availability of the guide(s). The architecture can also provide incentives to third-parties for authoring guides or content for guides as well as tools and/or templates to assist in guide creation. In addition, the architecture can receive requests from the device for guides as well as facilitate the output of the guide on the subscribing device.

### BACKGROUND

Conventional tours or travel guides are generally produced with the most common denominator of the potential audience in mind. Such tours or guides are therefore generic, applying a “one-size-fits-all” approach. Accordingly, a point of interest or travel destination (e.g. a “site”) that serves as a source or basis for tours or travel guides is approached by today's guides from a single perspective, typically an academic discussion of the site, and/or of the dominant features of the site. Often, less than central features of the site are not deemed economically viable to support the production of a guide or tour. As a result, secondary or tertiary features of the site, or even features that are esoteric, but related in some way are generally ignored or overlooked. Furthermore, families, for example, who travel together but maintain disparate sets of interests are likely to have varying levels of satisfaction with any particular tour or guide with little or no recourse for personalizing a guide to one's own tastes.

Moreover, conventional guides, even when they are particularly suited to and desired by an individual, require a degree of discovery on behalf of the individual to locate the guide. For example, the individual typically must be informed of the existence of the site as well as the location of the site, and thereafter visit the site in search of the desired tour or guide, which may or may not be a successful production and/or meet the individual's expectations.

In addition, an area of interest for one individual may not be considered interesting to the population at large, and thus may not be monetized for tourism in any way. Hence, the site would not typically be presented by maps or directories and the rare interested individual may well travel in close proximity to the site without ever realizing the site exists.

### SUMMARY

The following presents a simplified summary of the claimed subject matter in order to provide a basic understanding of some aspects of the claimed subject matter. This summary is not an extensive overview of the claimed subject matter. It is intended to neither identify key or critical elements of the claimed subject matter nor delineate the scope of the claimed subject matter. Its sole purpose is to present some concepts of the claimed subject matter in a simplified form as a prelude to the more detailed description that is presented later.

The subject matter disclosed and claimed herein, in one aspect thereof, comprises a first architecture for facilitating an enhanced travel experience. In accordance with one aspect of the claimed subject matter, the architecture can determine a location of a subscribing mobile device and transmit a notification to the subscribing device indicating the existence of potential areas of interest (e.g. “sites”) as well as the existence of guides pertaining to that site. The notification can be based upon a profile associated with the subscribing device and can thus be tailored or personalized to the device and/or a user or owner of the device

In accordance with another aspect of the claimed subject matter, the architecture can aggregate informal communities associated with the site and provide an incentive to members of those community to author guides for public consumption. The incentive can be substantially any type of encouragement such as free or subsidized products or services, as well as a monetary incentive including a profit-sharing scheme based upon the popularity of the authored guide. In order to further aid in the creation of third-party guides, the architecture can provide a set of tools and/or templates to assist with guide production.

According to another aspect of the claimed subject matter, a second architecture can be provided for receiving and filtering the guides. In particular, the second architecture can receive a notification (e.g., from the first architecture) that indicates an availability of a set of guides. The second architecture can, e.g., reside on the subscribing device. Accordingly, the second architecture can be privy to information that a user or own of the subscribing device does not want to share with third parties. As a result, the second architecture can potentially select and/or filter guides more efficiently

The following description and the annexed drawings set forth in detail certain illustrative aspects of the claimed subject matter. These aspects are indicative, however, of but a few of the various ways in which the principles of the claimed subject matter may be employed and the claimed subject matter is intended to include all such aspects and their equivalents. Other advantages and distinguishing features of the claimed subject matter will become apparent from the following detailed description of the claimed subject matter when considered in conjunction with the drawings.

### BRIEF DESCRIPTION OF THE DRAWINGS

FIG. 1 is a block diagram of a system that can provide a guide and/or travel-based service to facilitate an enhanced travel experience.

FIG. 2 depicts a block diagram of a system that can employ a profile to facilitate an enhanced travel experience.

FIG. 3 illustrates a block diagram of example descriptive content for the guide.

FIG. 4 depicts a system that can classify guides to facilitate an enhanced travel experience.

FIG. 5 is a block diagram of a system that provides incentives to third parties to author guides and/or guide content.

FIG. 6 illustrates a block diagram of a system that can facilitate guide creation.

FIG. 7 is a block diagram of a system that subscribes to a service to facilitate an enhanced travel experience.

FIG. 8 depicts an exemplary flow chart of procedures that define a method for facilitating an enhanced travel experience.

FIG. 9 is an exemplary flow chart of procedures for a method for receiving a guide for enhancing a travel experience.

FIG. 10 illustrates a block diagram of a computer operable to execute the disclosed architecture.

FIG. 11 illustrates a schematic block diagram of an exemplary computing environment.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

As used in this application, the terms “component,” “module,” “system”, or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g. card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

As used herein, the terms to “infer” or “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

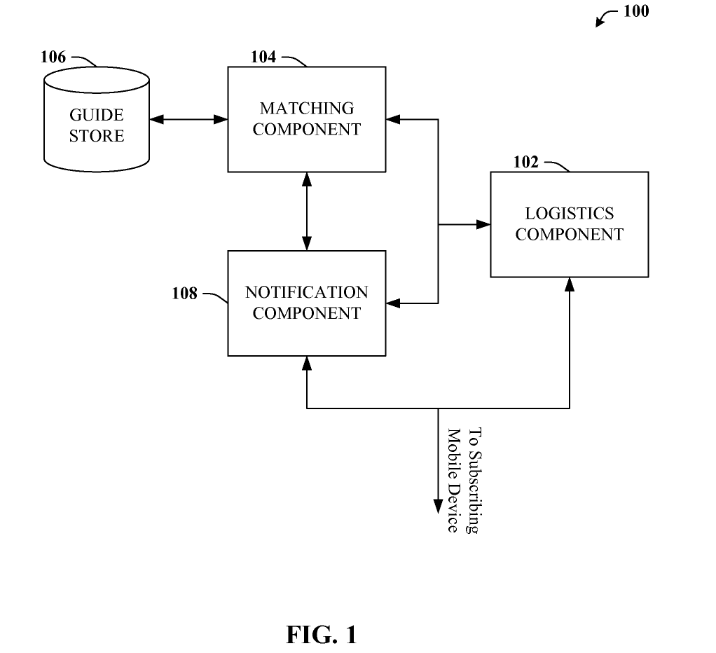

Referring now to the drawing, with reference initially to FIG. 1, a system 100 that can provide a guide and/or travel-based service to facilitate an enhanced travel experience is depicted. Generally, the system 100 can include a logistics component 102 that can determine a location of a subscribing mobile device (not shown). For example, the subscribing mobile device can be a device such as a cellular phone, laptop computer, Personal Digital Assistant (PDA) or another handheld or portable device that subscribes to the travel service. In accordance with an aspect of the claimed subject matter, the logistics component 102 can utilize a Global Positioning System (GPS) in order to determine the location of the subscribing device. For instance, a subscribing mobile device equipped with GPS or another type of location service and can relay positioning information to the logistics component 102.

According to another aspect, the logistics component 102 can be communicatively coupled to stationary terminals or kiosks, service towers, or the like existing at known locations and, e.g., adapted to detect subscribing devices within a given range. It is to be appreciated that the location of the subscribing device can be more precisely pinpointed by means known in the art such as Near Field Communication (NFC), WiFi (IEEE 802.11x specifications), Bluetooth (IEEE 802.15.x specifications), Radio Frequency Identification (RFID), infrared, and so forth.

Regardless of the manner in which the location of the subscribing device is determined, a matching component 104 can utilize such location information in order to select a guide associated with a “site” in proximity to the location of the subscribing device. A site can be defined as substantially any point of interest and/or travel destination. For example, a site can be a tourist attraction, a travel destination or venue, the site of an historical event, a current event, a monument, or even an entire city, as well as many other examples. It is to be appreciated that the site can generally be associated with both a single location (e.g. a famous sculpture) or a set of locations (e.g. a tour of a metropolitan city), however, in some cases, the term site can be limited to one or the other.

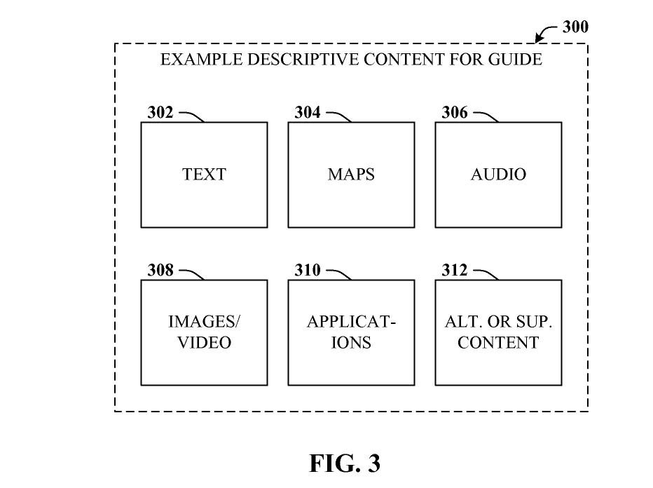

In accordance therewith, the matching component 104 can initially determine nearby sites (e.g., points of interest) with respect to the subscribing device. Thereafter, the matching component 104 can, e.g., access a guide store 106 to locate suitable guides in connection with the site. A guide can exist in many different formats (e.g. an audio tour, video tour, . . . ) as will be described in more detail in connection with FIG. 3, however, it should be understood that a guide, as used herein, is generally intended to refer to more than names or listings of points of interest. In particular, a guide can include substantive descriptive content relating to a site such as, e.g., in-depth background information, a series of waypoints/checkpoints, dramatizations, portrayals, audio, visual, or virtual reconstructions or objects, alternative and/or supplemental content for other existing guides, etc. In addition, it is also to be appreciated that the guide store 106 can include guides associated with a plurality of disparate sites and, as such, is not limited to a store of guides that relate only to a single location or set of locations for one particular site.

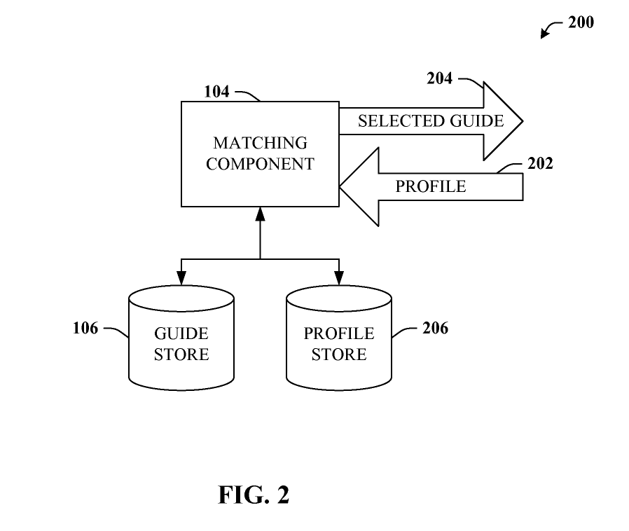

Thus, the matching component 104 can determine sites in proximity to the subscribing device as well as which guides relating to those sites are appropriate for selection. According to an aspect, the matching component 104 can employ a profile associated with the subscribing device. This aspect is detailed further with reference to FIG. 2, but briefly, the subscribing device can include a profile that relates to, e.g., demographics, types of interests, sites, activities, formats, etc. that are preferred (e.g., preferences set by a user of the subscribing device). Hence, the preferred types of interests, etc. can be matched to the available guides to personalize or tailor the selection of the guide.

The system 100 can also include a notification component 108 that can notify the subscribing device of an availability of the guide. For example, the notification component 108 can provide a notification to the subscribing device that items of potential interest can be accessed by the subscribing device. The notification component 108 can also establish a communication session with the subscribing device to facilitate a download of the guide to the subscribing device. It is to be appreciated that the guide can be downloaded and/or delivered according to a variety of protocols (e.g., wifi, Bluetooth, NFC as well as WiMAX), and the guide can be delivered as a single download or in multiple segments such as providing a different portion/chapter of the guide for different locations or sites. Appreciably, in addition to a wide range of informative content, the guide can facilitate other entertainment in the form of a choose-your-own-adventure tour, a scavenger hunt tour, or many other types of tours, any or all of which can be further enriched by tailoring the experience to a particular user and/or subscribing device.

While still referencing FIG. 1, but turning also to FIG. 2, a system 200 that can employ a profile to facilitate an enhanced travel experience is illustrated. Typically, the system 200 can include the matching component 104 that can select a guide associated with a site in proximity to a location of a subscribing device. The matching component 102 can receive a profile 202 (e.g., from the subscribing device). The profile 202 can include a variety of information associated with a subscribing device (or a user thereof) including but not limited to transaction histories, demographics, preferences, and so on. Once received, the matching component 104 can store the profile 202 in, e.g. a profile store 206. Based upon the information included in the profile 202, the matching component can tailor the guide selection (e.g., from the guide store 106) to suit the profile 202, and then output a selected guide 204.

In order to provide additional context consider the following non-limiting example. Ashley and Ross are on vacation and en route to a beachside destination. Ashley enjoys gardening and horticulture while Ross is fascinated by architecture. Both Ashley and Ross have a subscribing mobile device, Ashley's device is a run-of-the-mill cellular phone, and Ross's device is a high-end handheld with GPS. While stopping for fuel, the logistics component 102 determines that Ross's mobile device (e.g., GPS coordinates are transmitted to the logistics component 102) is in close proximity to a famous cathedral (e.g. a site), renown for its architectural style. The cathedral includes a courtyard with an extravagant garden that might be interesting to Ashley as well, and since the logistics component 102 can also determine that Ashley's subscribing device is in proximity (e.g., wifi, or in some cases, Ashley's profile can be warehoused on Ross's device in addition to his own profile to leverage the GPS for her as well), to a potential area of interest, her profile can be matched as well.

In accordance therewith, the matching component 104 can receive a profile 202 for both Ashley and Ross suggesting that sites relating to architecture and/or gardening are preferred venues, information indicating that one or both are currently on vacation, as well as other information. In some cases, the matching component 104 might already have access to the profile(s) 202, in which case the profile(s) 202 can be retrieved from, e.g., the profile store 206 and/or updated with the most current information. In either case, the matching component 104 can access the guide store 106 in order to select a guide for one or both of the subscribing devices. In particular, the matching component 104 can select a guide relating to the construction and architecture of the cathedral for Ross and a guide relating to a historical figure who supplied the funding for the garden for Ashley. In either case, the notification component 108 can transmit a message indicating that a guide relating to the site can be accessed.

Referring to FIG. 3, example descriptive content 300 for the guide is depicted. As indicated supra, the guide can be provided in a variety of formats, yet generally includes more than names or a listings of points of interest. For example, the guide can be entirely text 302—based, with a history and timeline of the site. In addition, the guide can also include maps 304 (e.g. orthographic projections, walk-through of the site with waypoints for further description, etc.) or diagrams (e.g., reconstructions, various stages of construction, etc.). Additionally or alternatively, the descriptive content 300 can include audio tours 306 as well as images, video, or web content 308. Moreover, the descriptive content 300 can include applications 310 that can be downloaded and launched on the subscribing device to provide or enrich the guide.

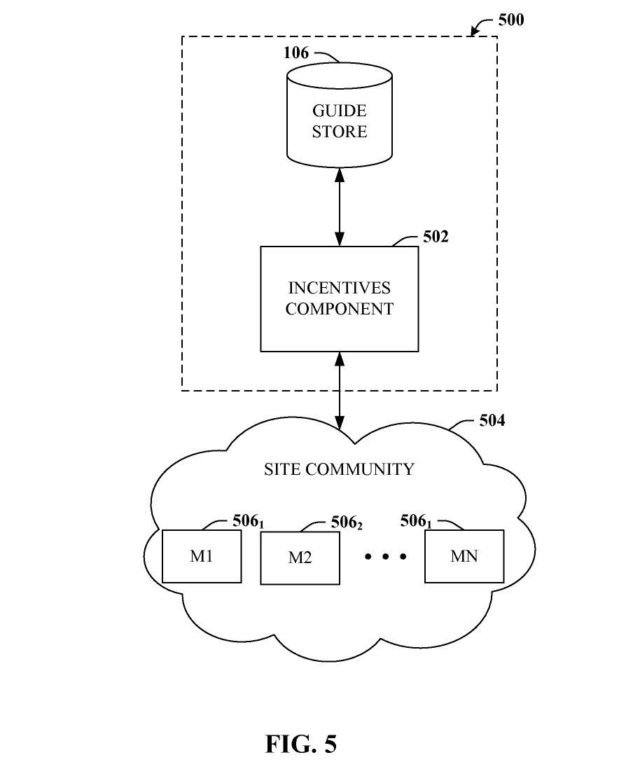

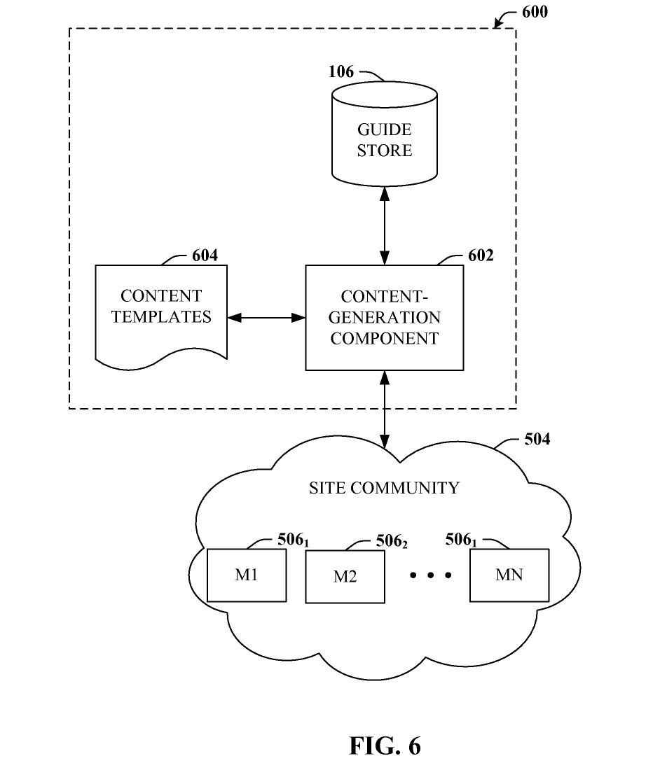

As another example, the descriptive content 300 can be based upon an existing guide, but provide alternative or supplemental content 312. For example, administrators of the site might provide a general admittance public tour of the cathedral, with a tour guide/host who is very knowledgeable with respect to, say, theological matters. However, another guide may exist with a different focus (e.g., architecture or gardening), that can be based upon the route or other aspects of the theological tour. Further description relating to these and other features can be found with reference to FIGS. 5 and 6 infra. However, turning again to FIG. 1, it should be appreciated and understood that the matching component 104 can select appropriate guides for subscribing devices based upon a type of descriptive content 300 included in the guide, as well as based upon numerous other factors. For instance, it is readily apparent that if a particular guide is comprised entirely of video 308 descriptive content, that particular guide need not be a candidate for selection for a subscribing device that is not equipped to enable video 308. This, as well as other, information can be included in the profile for the subscribing device.

As mentioned above, the matching component 104 can utilize transaction histories, demographics, preferences and so on in order to select an appropriate guide for the subscribing device. In addition, the matching component 104 can employ device type or device features information to make the device selection as well as a mode of travel associated with a user of the device. For example, as with the scenario above, Ashley and Ross can indicate that their mode of travel is vacationing (as opposed to, say, business travel). In other aspects, the mode of travel can be inferred based upon other available information (e.g., transaction histories). Hence, the matching component 104 can, e.g. select different guides based upon the travel mode. As an example, the matching component 104 can employ a larger radius of proximity between a current location of the subscribing device and the site, given that a vacationing mode is more likely to welcome excursions and/or detours than other modes of travel.

It is to be appreciated that the matching component 104 can utilize any or all of the aforementioned information as well as other sets of data, any or all of which can be included in a profile that is received from a subscribing device or stored in a profile store, in order to make the guide selection. In particular, the matching component 104 can examine the entirety or a subset of the data available and can provide for reasoning about or infer states of the system, environment, and/or user from a set of observations as captured via events and/or data to select an appropriate guide suitable for the subscribing device. Inferences can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data.

Such inference can result in the construction of new events or actions from a set of observed events and/or stored event data, whether or not the events are correlated in close temporal proximity, and whether the events and data come from one or several event and data sources. Various classification (explicitly and/or implicitly trained) schemes and/or systems (e.g. support vector machines, neural networks, expert systems, Bayesian belief networks, fuzzy logic, data fusion engines . . . ) can be employed in connection with performing automatic and/or inferred action in connection with the claimed subject matter.

A classifier can be a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hypersurface in the space of possible inputs, where the hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

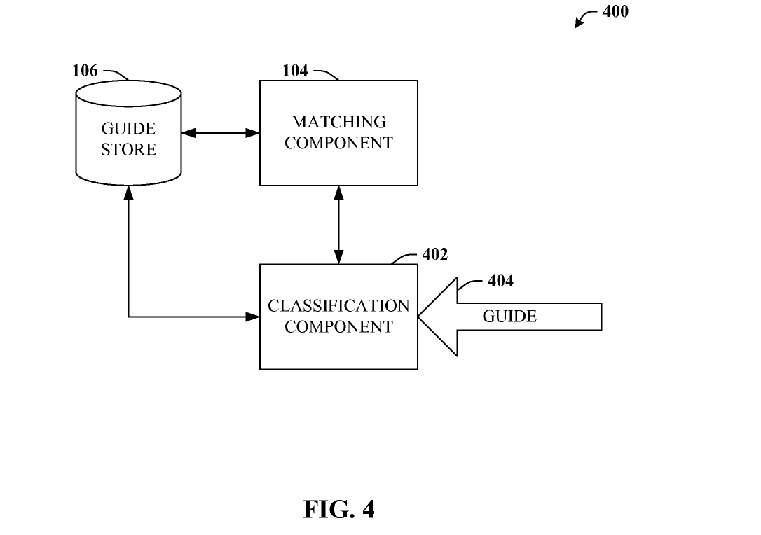

With reference now to FIG. 4, a system 400 that can classify guides to facilitate an enhanced travel experience is illustrated. The system 400 can include the matching component 104 that is communicatively connected to the guide store 106. The system 400 can also include a classification component 402 that receives the guide 404 and assigns a category to the guide 404. Typically, the classification component 402 receives the guide 404 from a remote source, assigns the guide 404 a category, and stores the categorized guide in the guide store 106. However, it is to be appreciated that the classification component 402 can receive the guide from the guide store 106 such as when the guide store 106 includes guides 404 that are not categorized, when the classification of the guide store 106 is updated, or when a new view of the guide store 106 is implemented (e.g., a different view of the guide store 106 can exist for each subscribing device). In addition, the classification component 402 can also receive the guide 404 by way of the matching component 104, which may in some cases act as an intermediary between the remote third party or the guide store 106.

The classification component 402 generally assigns the category based upon the content included within the guide 404. For example, the guide 404 can include content that indicates an appropriate categorization (e.g., architecture, gardening, . . . ). In addition, the classification component 402 can examine the guide 404 as well as a variety of other data in order to intelligently determine or infer the category in a manner similar to the inferences that can be performed by the matching component 104 described supra. According to an aspect of the claimed subject matter, once the guide 404 is categorized, the matching component 106 can select the guide 404 based upon the category assigned. For instance, categorizing the guide 404 can be based upon the type of data available in the profiles since the categorization can make the matching of a guides 404 more efficient and/or more relevant. Thus, in the case where a particular profile includes only a limited set of categories, then the classification component 402 can categorize the guide 404 into one or more of category of the limited set for a particular subscribing device. However, it is to be appreciated that a second subscribing device may include a different style of profile and thus may be presented a different view and/or categorization of the guide 404. It is to be further appreciated, however, that the category can also be assigned on a global basis that can be viewed in the same manner for all subscribing devices.

Turning now to FIG. 5, a system 500 that provides incentives to third parties to author guides and/or guide content is illustrated. The system 500 can include a guide store 106 for storage of guides as well as an incentives component 502. The incentives component 502 can potentially identify as well as aggregate informal communities associated with a particular site (e.g., a site community 504). For example, the incentives component 502 can provide incentives to encourage members 506₁-506_{N} (referred to herein either individually or collectively as members 506) of the site community 504 to exchange information or ideas relating to the site. For instance, scholars, enthusiasts, historians, locals or the like can utilize the platform to exchange information and/or ideas relating to the site. The information can be in virtually any format such as boards, weblogs, pamphlets, treatises, etc. and the site community 504 can, depending upon the implementation, require formal membership and/or be moderated to some degree or simply be comprised of members that share an interest in the site but have not actively engaged in any type of registration process. Moreover, the incentives component 502 can provide an incentive to members 506 of the community 504 to create content in the form of guides that can be consumed by a subscribing device.

For example, referring back to the scenario above, Ross may be very intrigued with the architecture of the cathedral and may decide to become involved with the site community 504 for that particular site. Ross believes that certain features represented by the architecture are the earliest example of a particular style that is widely believed to originate with a different architect. Ross composes his thoughts and posts the work to the platform for the site community 504, including photographs he snapped during the theological tour of the site. Ross also includes a historical snippet describing social ties and collaborative work between the two architects in question to support his theory that the architectural style might have originated from a source other than what is widely believed.

Encouraged by Ross's discovery, Ashley decides to contribute as well. In particular, during her investigation of the garden, she noted several species of plants within a genus that is very rare given the climate of the site. Ashley also posts pictures along with a map of the garden marking where each a specimen for each of the species of plant can be found as well as a discussion of aspects of interest to her. In either case, the incentives component 502 can provide an incentive to Ashley or Ross to create a guide.

In accordance with one aspect of the claimed subject matter, the incentive can be, e.g., an economic incentive such as a monetary reward that can be based upon the popularity of the guide. For example, access to the guides can be provided in exchange for subscription fees or a surcharge for each guide as it is downloaded to a subscribing device. In either case, the revenue generated by any given guide can be tracked and/or estimated and a portion of that revenue can be distributed to the content author(s). According to other aspects, the incentive can be free or subsidized subscriptions or memberships, access to a set number of other guides, or for a set amount of time, reward points as well as virtually any other suitable incentive including products or services such as from third party sponsors or the like. In addition, the incentive can be merely name recognition or personal satisfaction acquired from reviews or rankings by other members 506, which can be assessed in the aggregate such that a ranking from a particular party (e.g., the content author) does not dominate unduly. Moreover, it is to be appreciated that the reviews and/or rankings can themselves be reviewed or ranked.

Assuming that Ashley and Ross do create guides, the incentive component 502 can store those guides in the guide store 106. It is to be further appreciated that the incentives component 502 can first transmit the guide to the classification component 402 of FIG. 4 in order to categorize the guide prior to storing the guide in the guide store 106.

FIG. 6 depicts a system 600 that can facilitate guide creation. Generally, the system 600 can include the guide store 106 for storage and retrieval of guides and a content-generation component 602. It is to be appreciated that the content-generation component 602 can be accessible by way of substantially any particular site community 504 as well as by formal or informal members 506 of the site community 504. The content-generation component 602 can be employed to aid members 506 of the site community 504 in creation of the guide.

In particular, the content-generation component 602 can include or be operatively coupled to a set of content templates 604. The content templates 604 can be based upon a variety of data. For example, a template 604 can be provided based upon the equipment employed to create the guide. Thus, a voice recorder can implicate an audio content template 604, which can be quite different from other content templates 604. As another example, the content templates 604 can be based upon other guides in a variety of ways. Hence, a template 604 can indicate that, say, historically, the most popular audio-visual guides traditionally include an introduction with theme music followed by series of photographs, then a more detailed discussion of each of the photographs in succession. Hence, audio-visual guide can select this (or another) template 604 and follow the template 604 as closely or as loosely as desired. As another example, the guide can be based upon another guide such as when employing one guide but supplying alternative and/or supplemental content. Accordingly, such a guide could be based upon a template 604 that itself is based upon the format, timeline, route or path of the underlying guide.

For example, and again returning to the scenario introduced supra, since Ross made his discovery during the theological tour of the cathedral, he decides to use that tour as a basis for his own guide. The content-generation component 602 can, e.g. locate the theological tour template or locate the tour itself from the guide store 106 and dynamically generate a template 604. Hence, as the theological tour proceeds through the cathedral, Ross's guide discusses aspects of architecture that he captured with photographs of his own, and each is discussed in turn at locations within the site in which those aspects are visible.

On the other hand, Ashley decides to use an entirely different template 604. Instead, she decides to author her guide in the form of a game. Ashley's guide indicates up front that there are at least 12 species of plants from a particular genus that are extremely rare for this location and asks the audience to locate those 12 plants that are distributed throughout the garden section of the cathedral. The template 604 Ashley employs suggests that these types of guides are more popular if they include time limitations, so Ashley selects from the template a time frame of 45 minutes to find all 12 species of plants. At the conclusion of Ashley's guide, the map she created is displayed noting where she located each of the 12 plant species. It is to be appreciated that the scenarios and examples included herein are intended to be exemplary, provided for the sake of illustration, but are not intended to limit the claimed subject matter to just those particular examples.

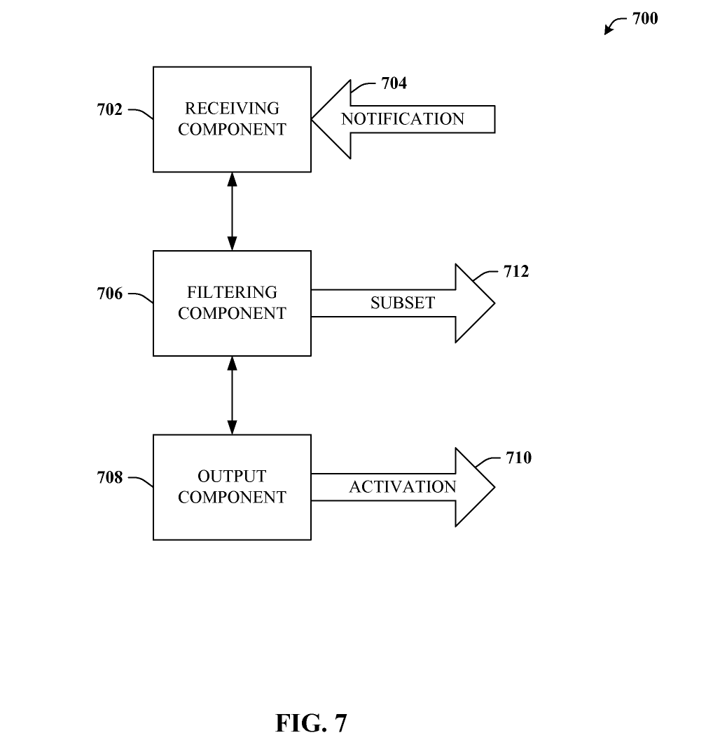

Referring to FIG. 7, a system 700 that subscribes to a service to facilitate an enhanced travel experience can be found. In more detail, the system 700 can include a receiving component 702 that can receive a notification 704 associated with an availability of a guide. It is to be appreciated that the system 700 can be included in a subscribing mobile device. Accordingly, the notification 704 can originate from a component of a remote service such as, e.g., the notification component 108 of FIG. 1. The notification 704 can pertain to a site in proximity to a current location of the subscribing mobile device and/or the system 700. It is to be appreciated that the current location of the system 700 can be determined by means known in the art by the remote service or by the subscribing device and then forwarded to the remote service. It is to be further appreciated that the notification 704 can relate to the availability of a personalized guide in that, e.g. the guide has been selected specifically tailored to the subscribing device or a user of that device, as will be further detailed infra.

The system 700 can also include a filtering component 706 that can filter the guide based upon a set of preferences. For example, the filtering component 706 can supply and/or access the set of preferences to aid in determining suitable or appropriate guides. For instance, the set of preferences can include a listing of interests, likes, dislikes, hobbies, demographic information, buddy lists and other associations, multiple profiles, current mode of travel, and so on. Accordingly, the filtering component 706 can employ any or all of the available preference data, as well as other data in order to filter or match available guides to the preferences of the subscribing device in a manner substantially similar to the determinations and/or inferences described supra in connection with the matching component 104 of FIGS. 1, 2 and 4.

It should be understood, that while the matching component 104 can utilize the same or a similar set of preferences as the filtering component 706 to select (e.g., tailor or personalize) the guide associated with the notification 704, such matching is necessarily performed by the remote service and generally requires access to information that some users may not be willing to provide or share. In contrast, the filtering component 706 can reside locally on the subscribing device, and thus employ information that may not be available to the matching component 706. Accordingly, in one aspect of the claimed subject matter, the filtering component 706 can transmit a subset 712 of the set of preferences to the remote service (e.g., the matching component 104) to facilitate effective matching or tailoring of guides to the subscribing device. The subset 712 can include preferences that a user of the subscribing device does not mind sharing with third parties such as, e.g., the mode of travel and hobbies, but may not include certain demographic information such as a user's annual income. However, even in the cases in which such information is not available to the matching component 104, the information may be available to the filtering component 706 and useful in further tailoring and/or personalizing the choice of guides to offer.

Once the guide has been filtered by the filtering component 702, and, for example, a user of the subscribing device has indicated that the guide is desirable, an output component 708 activate the guide (e.g., download the guide and/or instantiate the guide) to output 710 and/or display on the subscribing device.

Returning once more to the familiar scenario, Ashley has a mobile phone with a Bluetooth earpiece. While touring the famous Aquatic Gardens at her vacation destination, she indicates (e.g., sets preferences) that she only wants audio guides that she can listen to while she strolls through the site. She does not mind sharing this preference with the service and, in fact, desires to do so such that she only receives notifications 704 for audio guides. Accordingly, the filtering component 706 can transmit this preference (e.g., subset 712) to the remote service and, e.g., a profile associated with Ashley or her subscribing device can be updated. In contrast, Ashley does not want to reveal her age, so this information is not included in the subset 712 transmitted to the remote service. As a result, while Ashley is over 40, the receiving component 702 may receive notifications 704 relating to guides directed to the 20-somethings or “hip” crowd.

However, the filtering component 706, which, unlike the remote service, may be privy to the information relating to Ashley's age or other demographic information, might appropriately filter these guides. As a result, Ashley receives a list of availability of guides that she finds perfectly suited to her tastes. As she strolls through the site, listening through her Bluetooth earpiece to the audio guides relating to the site, she can be presented with additional guides and/or notifications 704 based upon precise locations within the site. For example, her Bluetooth enabled cellular phone is equipped with an effective range of 10 meters (e.g., power class 2), which can be employed (e.g. by the logistics component 102 to determine a very precise location relative to, say, a stationary transceiver). Given suitable equipment (e.g., an optical pointing device, GPS, camera, video camera, or another type of I/O device), Ashley can point to objects within the site and query the remote service for guides pertaining specifically to that object.

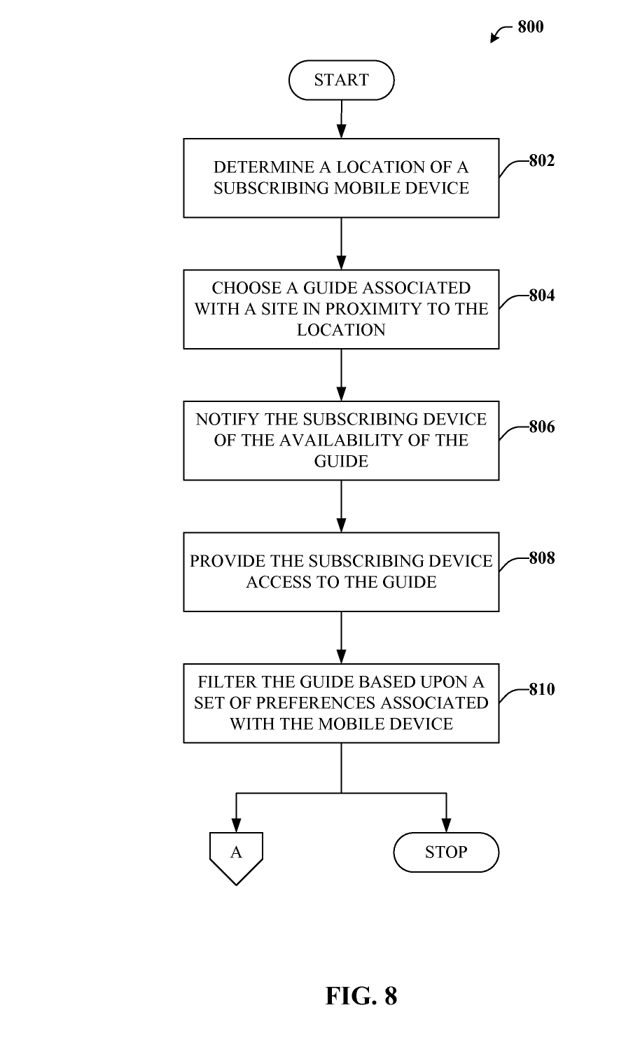

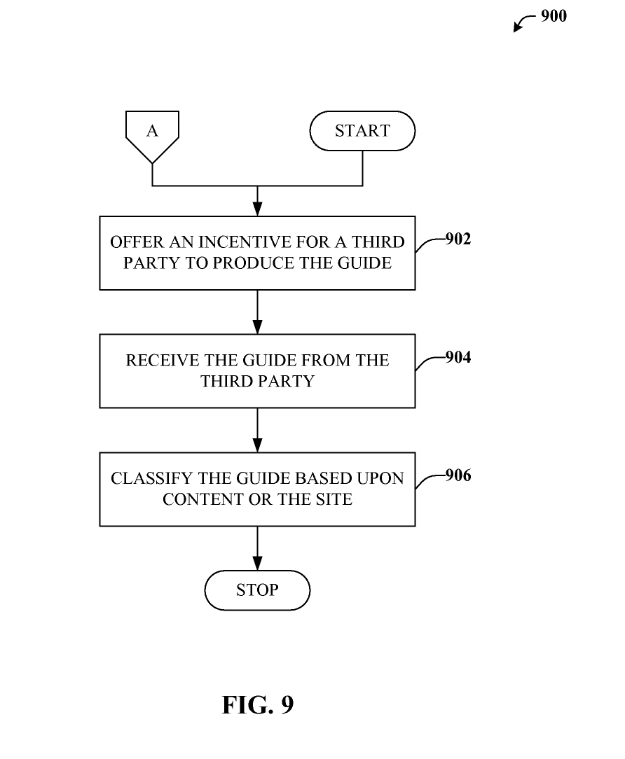

FIGS. 8 and 9 illustrate various methodologies in accordance with the claimed subject matter. While, for purposes of simplicity of explanation, the methodologies are shown and described as a series of acts, it is to be understood and appreciated that the claimed subject matter is not limited by the order of acts, as some acts may occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the claimed subject matter. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

Turning now to FIG. 8, an exemplary method 800 for facilitating an enhanced travel experience is depicted. Generally, at reference numeral 802, a location of a subscribing mobile device can be determined. Determining the location of the subscribing device can be accomplished in a number of ways, many of which are well-known. Among the ways for determining the location of a subscribing device include GPS, wifi, Bluetooth or other Personal Area Networks (PANs) such as NFC or the like. For example, communication ranges for Bluetooth or NFC can provide very high resolution for location discovery.

At reference numeral 804, a guide associated with a site in proximity to the location determined at act 802 can be chosen. It is to be appreciated that the guide can be chosen based upon the site (which is typically in close proximity to the determined location) as well as based upon a set of preferences associated with the subscribing device and/or a user of the subscribing device. For example, the guide can be personalized based upon a variety of information known about the subscribing device (or user).

At reference numeral 806, the subscribing device can be notified of the availability of the guide. A guide that relates to the site and also matches the preferences and/or profile of the subscribing device can be such a guide. At reference numeral 808, the subscribing device can be provided access to the guide. And at reference numeral 810, the guide can be filtered based upon a set of preference associated with the mobile.

Referring now to FIG. 9, an exemplary method 900 for receiving a guide for enhancing a travel experience is illustrated. At reference numeral 902, an incentive for a third party to produce the guide can be provided. The incentive can be an economic incentive such as a flat fee or a market share of revenue associated with the guide. In addition, the incentive can be points-based rewards and/or a free or subsidized product or service, including but not limited to products or services from third party sponsors.

At reference numeral 904 the guide can be received from the third party. In exchange, producing the guide, the incentive offered at act 902 can be provided to the third party. At reference numeral 906, the received guide can be classified based upon a variety of factors such as the site, a categorization within the site, a location within the site, content included in the guide and so on. Typically, the act of classifying can be employed to aid in matching and/or tailoring or personalizing the guide.

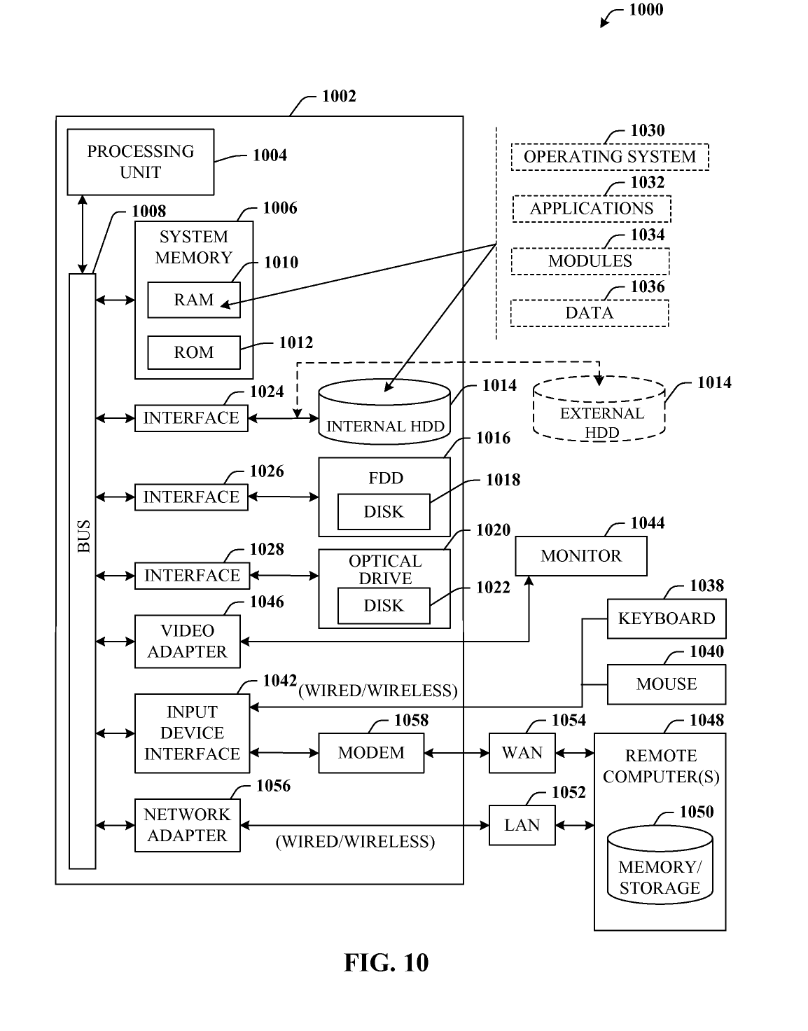

Referring now to FIG. 10, there is illustrated a block diagram of an exemplary computer system operable to execute the disclosed architecture. In order to provide additional context for various aspects of the claimed subject matter, FIG. 10 and the following discussion are intended to provide a brief, general description of a suitable computing environment 1000 in which the various aspects of the claimed subject matter can be implemented. Additionally, while the claimed subject matter described above can be implemented in the general context of computer-executable instructions that may run on one or more computers, those skilled in the art will recognize that the claimed subject matter also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the claimed subject matter may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media can include both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 10, the exemplary environment 1000 for implementing various aspects of the claimed subject matter includes a computer 1002, the computer 1002 including a processing unit 1004, a system memory 1006 and a system bus 1008. The system bus 1008 couples to system components including, but not limited to, the system memory 1006 to the processing unit 1004. The processing unit 1004 can be any of various commercially available processors. Dual microprocessors and other multi-processor architectures may also be employed as the processing unit 1004.

The system bus 1008 can be any of several types of bus structure that may further interconnect to a memory bus (with or without a memory controller), a peripheral bus, and a local bus using any of a variety of commercially available bus architectures. The system memory 1006 includes read-only memory (ROM) 1010 and random access memory (RAM) 1012. A basic input/output system (BIOS) is stored in a non-volatile memory 1010 such as ROM, EPROM, EEPROM, which BIOS contains the basic routines that help to transfer information between elements within the computer 1002, such as during start-up. The RAM 1012 can also include a high-speed RAM such as static RAM for caching data.

The computer 1002 further includes an internal hard disk drive (HDD) 1014 (e.g., EIDE, SATA), which internal hard disk drive 1014 may also be configured for external use in a suitable chassis (not shown), a magnetic floppy disk drive (FDD) 1016, (e.g., to read from or write to a removable diskette 1018) and an optical disk drive 1020, (e.g., reading a CD-ROM disk 1022 or, to read from or write to other high capacity optical media such as the DVD). The hard disk drive 1014, magnetic disk drive 1016 and optical disk drive 1020 can be connected to the system bus 1008 by a hard disk drive interface 1024, a magnetic disk drive interface 1026 and an optical drive interface 1028, respectively. The interface 1024 for external drive implementations includes at least one or both of Universal Serial Bus (USB) and IEEE1394 interface technologies. Other external drive connection technologies are within contemplation of the claimed subject matter.

The drives and their associated computer-readable media provide nonvolatile storage of data, data structures, computer-executable instructions, and so forth. For the computer 1002, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the claimed subject matter.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. It is appreciated that the claimed subject matter can be implemented with various commercially available operating systems or combinations of operating systems.

A user can enter commands and information into the computer 1002 through one or more wired/wireless input devices, e.g. a keyboard 1038 and a pointing device, such as a mouse 1040. Other input devices (not shown) may include a microphone, an IR remote control, a joystick, a game pad, a stylus pen, touch screen, or the like. These and other input devices are often connected to the processing unit 1004 through an input device interface 1042 that is coupled to the system bus 1008, but can be connected by other interfaces, such as a parallel port, an IEEE1394 serial port, a game port, a USB port, an IR interface, etc.

A monitor 1044 or other type of display device is also connected to the system bus 1008 via an interface, such as a video adapter 1046. In addition to the monitor 1044, a computer typically includes other peripheral output devices (not shown), such as speakers, printers, etc.

The computer 1002 may operate in a networked environment using logical connections via wired and/or wireless communications to one or more remote computers, such as a remote computer(s) 1048. The remote computer(s) 1048 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1050 is illustrated. The logical connections depicted include wired/wireless connectivity to a local area network (LAN) 1052 and/or larger networks, e.g. a wide area network (WAN) 1054. Such LAN and WAN networking environments are commonplace in offices and companies, and facilitate enterprise-wide computer networks, such as intranets, all of which may connect to a global communications network, e.g. the Internet.

When used in a LAN networking environment, the computer 1002 is connected to the local network 1052 through a wired and/or wireless communication network interface or adapter 1056. The adapter 1056 may facilitate wired or wireless communication to the LAN 1052, which may also include a wireless access point disposed thereon for communicating with the wireless adapter 1056.

When used in a WAN networking environment, the computer 1002 can include a modem 1058, or is connected to a communications server on the WAN 1054, or has other means for establishing communications over the WAN 1054, such as by way of the Internet. The modem 1058, which can be internal or external and a wired or wireless device, is connected to the system bus 1008 via the serial port interface 1042. In a networked environment, program modules depicted relative to the computer 1002, or portions thereof, can be stored in the remote memory/storage device 1050. It will be appreciated that the network connections shown are exemplary and other means of establishing a communications link between the computers can be used.

The computer 1002 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g. computers, to send and receive data indoors and out; anywhere within the range of a base station. Wi-Fi networks use radio technologies called IEEE802.11 (a, b, g, etc.) to provide secure, reliable, fast wireless connectivity. A Wi-Fi network can be used to connect computers to each other, to the Internet, and to wired networks (which use IEEE802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

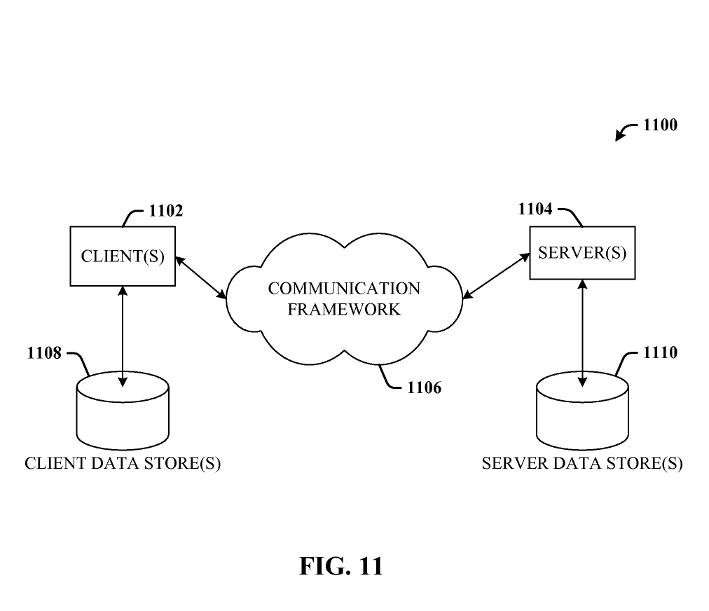

Referring now to FIG. 11, there is illustrated a schematic block diagram of an exemplary computer compilation system operable to execute the disclosed architecture. The system 1100 includes one or more client(s) 1102. The client(s) 1102 can be hardware and/or software (e.g., threads, processes, computing devices). The client(s) 1102 can house cookie(s) and/or associated contextual information by employing the claimed subject matter, for example.

The system 1100 also includes one or more server(s) 1104. The server(s) 1104 can also be hardware and/or software (e.g., threads, processes, computing devices). The servers 1104 can house threads to perform transformations by employing the claimed subject matter, for example. One possible communication between a client 1102 and a server 1104 can be in the form of a data packet adapted to be transmitted between two or more computer processes. The data packet may include a cookie and/or associated contextual information, for example. The system 1100 includes a communication framework 1106 (e.g., a global communication network such as the Internet) that can be employed to facilitate communications between the client(s) 1102 and the server(s) 1104.

Communications can be facilitated via a wired (including optical fiber) and/or wireless technology. The client(s) 1102 are operatively connected to one or more client data store(s) 1108 that can be employed to store information local to the client(s) 1102 (e.g., cookie(s) and/or associated contextual information). Similarly, the server(s) 1104 are operatively connected to one or more server data store(s) 1110 that can be employed to store information local to the servers 1104.

What has been described above includes examples of the various embodiments. It is, of course, not possible to describe every conceivable combination of components or methodologies for purposes of describing the embodiments, but one of ordinary skill in the art may recognize that many further combinations and permutations are possible. Accordingly, the detailed description is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g. a functional equivalent), even though not structurally equivalent to the disclosed structure, which performs the function in the herein illustrated exemplary aspects of the embodiments. In this regard, it will also be recognized that the embodiments includes a system as well as a computer-readable medium having computer-executable instructions for performing the acts and/or events of the various methods.

In addition, while a particular feature may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What is claimed is:

1. A system that provides a service to facilitate an enhanced travel experience, comprising:
a logistics component that determines a location of a subscribing mobile device;
a matching component that selects a guide associated with a site in proximity to the location; and
a notification component that notifies the subscribing device of an availability of the guide.

2. The system of claim 1, the logistics component utilizes at least one of a Global Positioning System (GPS) or a Wireless Application Protocol (WAP) to determine the location.

3. The system of claim 1, the matching component employs a profile associated with the subscribing device to select the guide.

4. The system of claim 1, the guide includes descriptive content associated with the site.

5. The system of claim 1, the guide includes alternative content to descriptive content of an extant guide.

6. The system of claim 1, further comprising a classification component that receives the guide and assigns a category to the guide based upon content included in the guide.

7. The system of claim 6, the matching component selects the guide based upon the category.

8. The system of claim 1, further comprising an incentive component that aggregates an informal community associated with the site and provides an incentive to members of the community to create the guide.

9. The system of claim 8, the incentive is an economic incentive based upon a popularity of the guide.

10. The system of claim 8, further comprising a content generation component that aids members of the community in creation of the guide.

11. The system of claim 10, the content generation component includes a set of templates.

12. The system of claim 1, the site is associated with a location or a set of locations that pertain to at least one of a tourist attraction, a current or historical event, a point of interest, a monument, a city, a town, a municipality, or a travel destination.

13. The system of claim 12, further comprising a data store that includes guides associated with a plurality of disparate sites, respectively.

14. A system that subscribes to a service to facilitate an enhanced travel experience, comprising:
a receiving component that receives from a remote service a notification associated with an availability of a personalized guide that pertains to a proximal site;
a filtering component that filters the guide based upon a set of preferences; and
an output component that activates the guide.

15. The system of claim 14, the filtering component transmits a subset of the set of preferences to the remote service.

16. The system of claim 14, the availability of the guide is based upon a location within the site.

17. The system of claim 14, the filtering component receives a plurality of guides and selects the guide based upon the set of preferences.

18. A method for facilitating an enhanced travel experience, comprising:
determining a location of a subscribing mobile device;
choosing a guide associated with a site in proximity to the location;
notifying the subscribing device of the availability of the guide; and
providing the subscribing device access to the guide.

19. The method of claim 18, further comprising filtering the guide based upon a set of preferences associated with the subscribing device, the act of filtering is performed by the subscribing device or the act of filtering is performed remote from the subscribing device

20. The method of claim 18, further comprising at least one of the following acts:
offering an incentive to a third party for producing the guide;
receiving the guide from the third party; and
classifying the guide based upon at least one of a type of content included in the guide or the site.
